(19) United States
(12) Patent Application Publication
(10) Pub. No.: US 2018/0302932 A1
(43) Pub. Date: Oct. 18, 2018

(54) SYSTEMS AND METHODS FOR FORMING A VIDEO CAMERA NETWORK

(71) Applicant: Shanghai Xiaoyi Technology Co., Ltd., Shanghai (CN)

(72) Inventors: Baoqi WANG, Shanghai (CN); Tao MA, Shanghai (CN); Chao HE, Shanghai (CN)

(73) Assignee: Shanghai Xiaoyi Technology Co., Ltd.

(21) Appl. No.: 15/487,893

(22) Filed: Apr. 14, 2017

(51) Int. Cl. H04W 76/02; H04L 29/12; H04W 12/08; H04W 4/06; H04L 29/08

(52) U.S. Cl. CPC H04W 76/02; H04L 61/2007; H04W 84/12; H04W 4/06; H04L 67/12; H04W 12/08

(57) ABSTRACT

A video camera system is provided. The video camera system comprises a video camera connectable to a wireless network via a wireless access point, and a user device including a memory storing a set of instructions and a hardware processor. The hardware processor is configured to execute the set of instructions to: establish a connection with the wireless network; determine that the video camera is connected to the wireless network; and establish a socket connection with the video camera.

### TECHNICAL FIELD

This disclosure generally relates to network technology, and more specifically relates to systems and methods for forming a video camera wireless network.

### BACKGROUND

With the advance of network and mobile technology, video cameras with wireless network connectivity are becoming commonplace. With the wireless network connectivity, a video camera can be remotely controlled to perform a video recording task, and/or to transmit recorded video data to another device. The capabilities of remotely operating a video camera can provide greater operation flexibility that lead to new applications. For example, a video camera can be remotely controlled by a user to take a picture of the user from a distance, when the user is performing other activities.

On the other hand, a system that includes multiple network connectible cameras controlled simultaneously by a single device can provide greater operation flexibility and lead to other new applications. For example, a network of cameras can be part of an immersive multi-media system (e.g., a virtual reality system, an augmented reality system, etc.), in which each camera of the network can be controlled to obtain images of a user at preset locations and at preset times. Based on the images, a system can determine a location and a movement of the user, and generate media data for displaying to the user accordingly, to create a virtual reality or augmented reality experience.

With current technologies, a video camera can be configured as a Wi-Fi access point (AP) to provide a Wi-Fi network. A user device (e.g., a smart phone, a tablet, a personal computer, etc.) with Wi-Fi capability can establish a connection with a single video camera by joining the Wi-Fi network, and can communicate with the video camera via the Wi-Fi connection. Although such an arrangement allows a user device (or multiple user devices) to connect to a single video camera as a Wi-Fi access point, the user device cannot directly connect to multiple Wi-Fi networks (or multiple cameras configured as Wi-Fi access points) at the same time. Therefore, it becomes difficult to form a multi-camera network with existing technologies.

### SUMMARY

Consistent with embodiments of this disclosure, there is provided a video camera system. The video camera system comprises a video camera connectable to a wireless network via a wireless access point, and a user device including a memory storing a set of instructions and a hardware processor. The hardware processor is configured to execute the set of instructions to: establish a connection with the wireless network; determine that the video camera is connected to the wireless network; and establish a socket connection with the video camera.

Consistent with embodiments of this disclosure, a method for operating a video camera connectable to a wireless network via a wireless access point is provided. The method comprises: establishing a connection with the wireless network; determining that the video camera is connected to the wireless network; and establishing a socket connection with the video camera.

Consistent with other disclosed embodiments, a non-transitory computer readable medium is further provided. The non-transitory computer readable medium stores instructions executable by a hardware processor to cause the hardware processor to perform any of the methods described herein.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is an exemplary camera network system consistent with disclosed embodiments.

FIG. 2 is a block diagram of an exemplary system for establishing a camera network, consistent with disclosed embodiments.

FIG. 3 is a flowchart of an exemplary method for establishing and operating a camera network, consistent with disclosed embodiments.

### DETAILED DESCRIPTION

Reference will now be made in detail to the disclosed embodiments, examples of which are illustrated in the accompanying drawings. The same reference numbers are used throughout the drawings to refer to the same or like parts.

These and other features and characteristics of the present disclosure, as well as methods of operation and functions of the related elements of structure and the combination of parts and economies of manufacture, may become more apparent upon consideration of the following description with reference to the accompanying drawing(s), all of which form a part of this specification. It is to be understood, however, that the drawing(s) are for the purpose of illustration and description only and are not intended as a definition of the limits of the invention. As used in the specification and in the claims, the singular form of “a”, “an”, and “the” include plural referents unless the context clearly dictates otherwise.

Embodiments of the present disclosure provide a video camera system. The video camera system comprises a video camera connectable to a wireless network via a wireless access point, and a user device. The user device can be, for example, a smart phone, a tablet, a personal computer, etc. The user device may establish a connection with the wireless network, determine that the video camera is connected to the wireless network, and establish a socket connection with the video camera, to control the video camera.

With embodiments of the present disclosure, a plurality of cameras can be configured to connect to the same Wi-Fi network as a user device (e.g., a smart phone). The user device may also establish network socket connections with each of plurality of cameras over the Wi-Fi network. As a result, the user device can communicate with and control the plurality of cameras simultaneously. This allows the plurality of cameras to perform certain operations that require the plurality of cameras to be controlled collectively and simultaneously, such as obtaining images of a user at preset times and at preset locations, to provide data for an immersive multi-media system. As a result, greater operation flexibility is provided for these cameras, and user experience can be improved.

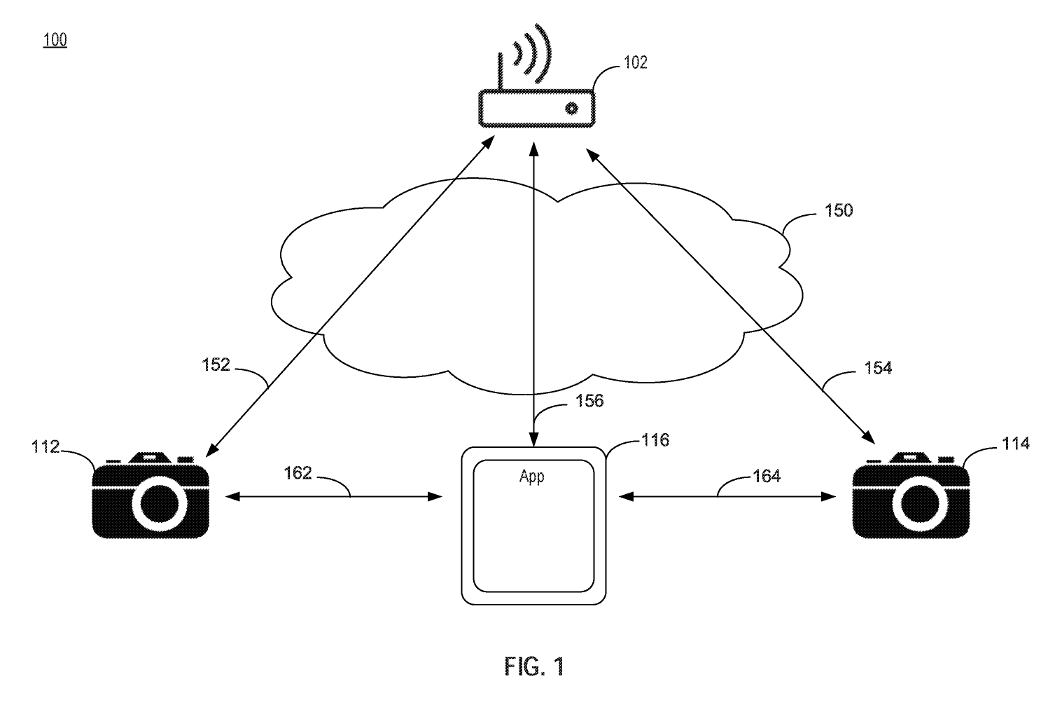

FIG. 1 is a block diagram illustrating an exemplary camera network system 100, consistent with disclosed embodiments. As shown in FIG. 1, system 100 includes a network connectivity provider 102, cameras 112 and 114, and a mobile device 116.

Network connectivity provider 102 can include a device that enables first camera 112, second camera 114, and mobile device 116 to connect to a Wi-Fi network 150. In some embodiments, network connectivity provider 102 includes a wireless router configured as a Wi-Fi hotspot, and each of cameras 112 and 114, and mobile device 116, can be configured as a Wi-Fi station. Network connectivity provider 102 can establish Wi-Fi connections 152, 154, and 156 with, respectively, cameras 112 and 114 and mobile device 116, to be a part of Wi-Fi network 150. In some embodiments, network connectivity provider 102 also provides connectivity to the Internet (not shown in FIG. 1), and may allow at least one of cameras 112 and 114 and mobile device 116 to access the Internet.

In some embodiments, each of cameras 112 and 114 includes a processor configured to execute software instructions for performing operations consistent with the disclosed embodiments, and an image capturing system configured to capture video images and to facilitate the generation of digital data representing the captured video images. Cameras 112 and 114 also include communication interfaces configured to transmit and receive data from a network. Mobile device 116 also includes a processor configured to execute software instructions (e.g., a mobile app) for performing operations consistent with the disclosed embodiments. In some embodiments, mobile device 116 may be a tablet, smartphone, a laptop, etc., and includes a communication interface configured to communicate with network connectivity provider 102 and each of cameras 112 and 114. As to be discussed in more detail below, mobile device 116 can establish, simultaneously, a network socket connection 162 with camera 112 and a network socket connection 164 with camera 114 over Wi-Fi network 150, and can transmit and receive data from the cameras via the network socket connections.

In a case where network connectivity provider 102 includes a wireless router configured as a Wi-Fi hotspot, connections 152, 154, and 156 between network connectivity provider 102 and each of cameras 112 and 114 and mobile device 116 can include a Wi-Fi station (STA) connection. Prior to establishing the Wi-Fi connection, each of cameras 112 and 114 and mobile device 116 can obtain configuration information including, for example, a Service Set Identifier (SSID) associated with wireless network 150 provided by network connectivity provider 102, a password associated with accessing the wireless network, etc. After receiving the configuration information, each of cameras 112 and 114 and mobile device 116 can transmit a request to establish a Wi-Fi connection (e.g., Wi-Fi connections 152, 154, and 156) with network connectivity provider 102. The request may include, for example, the SSID of Wi-Fi network 150, the password, and an identifier (e.g., a MAC address) of the device. After receiving the request, network connectivity provider 102 can establish the Wi-Fi connections with cameras 112 and 114 and mobile device 116, and enable the devices to receive and transmit data over Wi-Fi network 150. In some embodiments, each of cameras 112 and 114 and mobile device 116 may also receive an IP address assigned by network connectivity provider 102 for accessing the Internet, after establishing the respective Wi-Fi connections. As to be discussed in more detail below, the IP addresses also allow mobile device 116 to establish network socket connections 162 and 164 with cameras 112 and 114, respectively.

There are various ways by which cameras 112 and 114 and mobile device 116 can obtain the configuration information. For example, the configuration information can be stored in non-volatile storage devices (e.g., flash memory devices). Each of cameras 112 and 114 and mobile device 116 can acquire the configuration information from the non-volatile storage devices over a hardware interface. As another example, cameras 112 and 114 and mobile device 116 can receive the configuration information via other types of hardware interfaces, such as a display interface (e.g., touch-screen), imaging interface (e.g., by capturing an image that includes the configuration information), etc. As another example, before joining Wi-Fi network 150, each of cameras 112 and 114 and mobile device 116 can be connected to another network, and can receive the configuration information over their network interfaces. In this particular example, each of cameras 112 and 114 and mobile device 116 may be configured to provide a peer-to-peer connection associated with various protocols, such as Wi-Fi Direct, Bluetooth®, etc., with another device, and receive the configuration information from the other device.

In some embodiments, the initialization of transfer of the configuration information (e.g., reading a configuration file from a non-volatile storage device, receiving the configuration data from input, imaging, or network interface, etc.) can prompt cameras 112 and 114 and mobile device 116 to submit the requests for establishing the Wi-Fi connections with network connectivity provider 102 to join Wi-Fi network 150. In some embodiments, cameras 112 and 114 can be preconfigured to operate in Wi-Fi Access Point (AP) mode, and after receiving the configuration information, can be configured to operate in Wi-Fi Station (STA) mode and become Wi-Fi stations.

After each of cameras 112 and 114 and mobile device 116 establishes a Wi-Fi connection with network connectivity provider 102 using the configuration information, mobile device 116 may establish, simultaneously, network socket connection 162 with camera 112, and network socket connection 164 with camera 114, over Wi-Fi network 150. The network socket connections enable mobile device 116 to transmit and receive data with each of cameras 112 and 114.

In some embodiments, each network socket connection can include a Transmission Control Protocol (TCP) socket established based on an IP address. As discussed above, each of cameras 112 and 114 and mobile device 116 may receive an assigned IP address. After each device receives its own assigned IP address, each device can create a TCP socket, which allows it to establish a TCP socket connection with another device over Wi-Fi network 150.

In some embodiments, mobile device 116 is configured as a TCP client and can initiate a TCP socket connection with cameras 112 and 114. To establish network socket connection 162 with camera 112, mobile device 116 first obtains the IP address assigned to camera 112. Mobile device 116 can then create a network socket connection request message including the assigned IP address of camera 112 and the assigned IP address of mobile device 116, and transmit the request message via Wi-Fi network 150 to camera 112. After camera 112 receives the request message, it can determine a port for the network socket connection, and set the TCP socket to a listen state, to establish network socket connection 162. Mobile device 116 can then communicate with camera 112 over the established network socket connection. Mobile device 116 can also establish network socket connection 164 by a similar process as for establishing network socket connection 162. In some embodiments, each of cameras 112 and 114 may also be configured as a TCP client, and can each initiate the establishment of TCP socket connection with mobile device 116 in a similar process as discussed above.

There are different ways by which mobile device 116 can obtain the assigned IP addresses of cameras 112 and 114. As an illustrative example, mobile device 116 may obtain a list of devices connected to Wi-Fi network 150, and their assigned IP addresses, from network connectivity provider 102. As another illustrative example, mobile device 116 may also broadcast a message targeted at every device connected to Wi-Fi network 150 (e.g., a ping message). Each recipient device of the broadcast message can then transmit its IP address, as a reply to the ping message, back to mobile device 116.

After establishing the network socket connections with each of cameras 112 and 114, mobile device 116 can then communicate with the cameras to coordinate their operations. For example, mobile device 116 may be operating a virtual reality app. The virtual reality app may receive an instruction, through the display interface of mobile device 116, to set camera 112 to obtain a first image of a user at a first preset time and at a first preset location, and to set camera 114 to obtain a second image of the user at a second preset time and at a second preset location, and to transmit the first and second images back to mobile device 116. Mobile device 116 can then transmit data related to the instructions to cameras 112 and 114 via, respectively, network socket connections 162 and 164. Mobile device 116 can also receive the first and second images from cameras 112 and 114 via these network socket connections. The virtual reality app may then determine a location and/or an action of the user, based on the first and second images. The virtual reality app may also configure a display of multi-media data according to determined location and/or action of the user, to create a virtual reality experience.

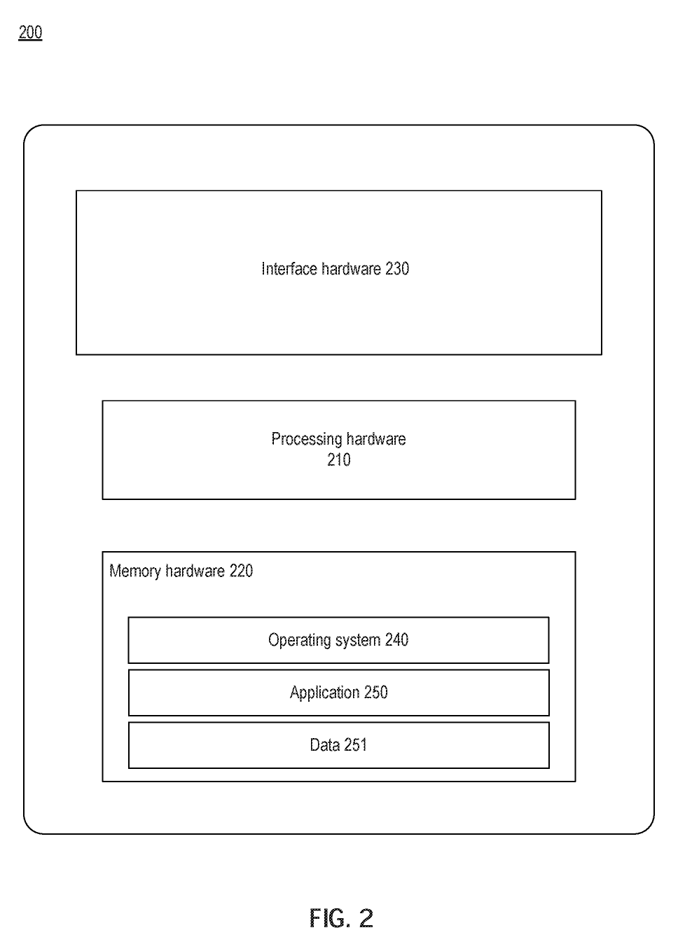

FIG. 2 depicts an exemplary system 200, which can be configured as cameras 112 and 114, and/or mobile device 116 of FIG. 1. System 200 includes processing hardware 210, memory hardware 220, and interface hardware 230.

Processing hardware 210 may include one or more known processing devices, such as a general purpose microprocessor, a microcontroller, etc. that are programmable to execute a set of instructions. Memory hardware 220 may include one or more storage devices configured to store instructions executed by processor 210 to perform functions related to disclosed embodiments. For example, memory hardware 220 may be configured to store software instructions, such as an operating system 240 and an application 250 that perform operations when executed by processing hardware 210. The disclosed embodiments are not limited to separate programs or computers configured to perform dedicated tasks. Memory hardware 220 may also store data 251 that the system uses to perform operations consistent with disclosed embodiments.

Interface hardware 230 includes interfaces to I/O devices, as well as network interfaces. For example, the I/O devices may include output devices such as a display, a speaker, etc., while input devices may include a camera unit, hardware buttons, touch screen, etc. Network interfaces may include wireless connection interfaces under various protocols (e.g., Wi-Fi, Bluetooth®, cellular connection, etc.), wired connections (e.g., Ethernet), etc. The network interface of interface hardware 230 enables system 200 to interact with other devices (e.g., network connectivity provider 102, cameras 112 and 114, and mobile device 116, etc.), while the I/O interface of interface hardware 230 enables system 200 to interact with a user. For example, with interface hardware 230, each of cameras 112 and 114 and mobile device 116 can receive configuration information for connecting to Wi-Fi network 150 (e.g., SSID, password, etc.) from a user, from a storage device, etc., and use the configuration information to connect to Wi-Fi network 150.

System 200 is configured to execute software instructions of operating system 240 and application 250. Operating system 240 may include, for example, a Linux operating system. The Linux operating system may include software modules configured to control the network interface of interface hardware 230. For example, the Linux operating system may receive, via the network interface, an assigned IP address of system 200, as well as the assigned IP addresses of other devices, and create a TCP socket based on these IP addresses. The Linux operating system may also generate data packets, and then transmit the data packets over the network socket connections via the network interface. The Linux operating system may also enable each of cameras 112 and 114 and mobile device 116 to establish a Wi-Fi STA connection with network connectivity provider 102.

Application 250 includes one or more software modules configured to provide various functionalities described in this disclosure. For example, application 250 may include a mobile app which, when executed by processing hardware 210, causes system 200 to display a graphical user interface for displaying information to a user and prompting the user to input information, such as the aforementioned configuration information (SSID, password, URL of target server, etc.). Application 250 may also receive configuration information through other interfaces (e.g., imaging interface) and determine the SSID and password from the received information. Application 250 may also interact with various components of operating system 240 to provide various functionalities, such as establishing a Wi-Fi STA connection between each of cameras 112 and 114 and mobile device 116 with network connectivity provider 102, obtaining the IP addresses of the devices connected to Wi-Fi network 150, establishing network socket connections with each of these devices, communicating with each of these devices via the established network socket connections, and performing computations and processing based on a result of the communications. For example, application 250 may include a virtual reality app, or an application programming interface (API) that communicates with the virtual reality app, and operates, remotely, cameras 112 and 114 to provide data to create a virtual reality experience, as discussed above.

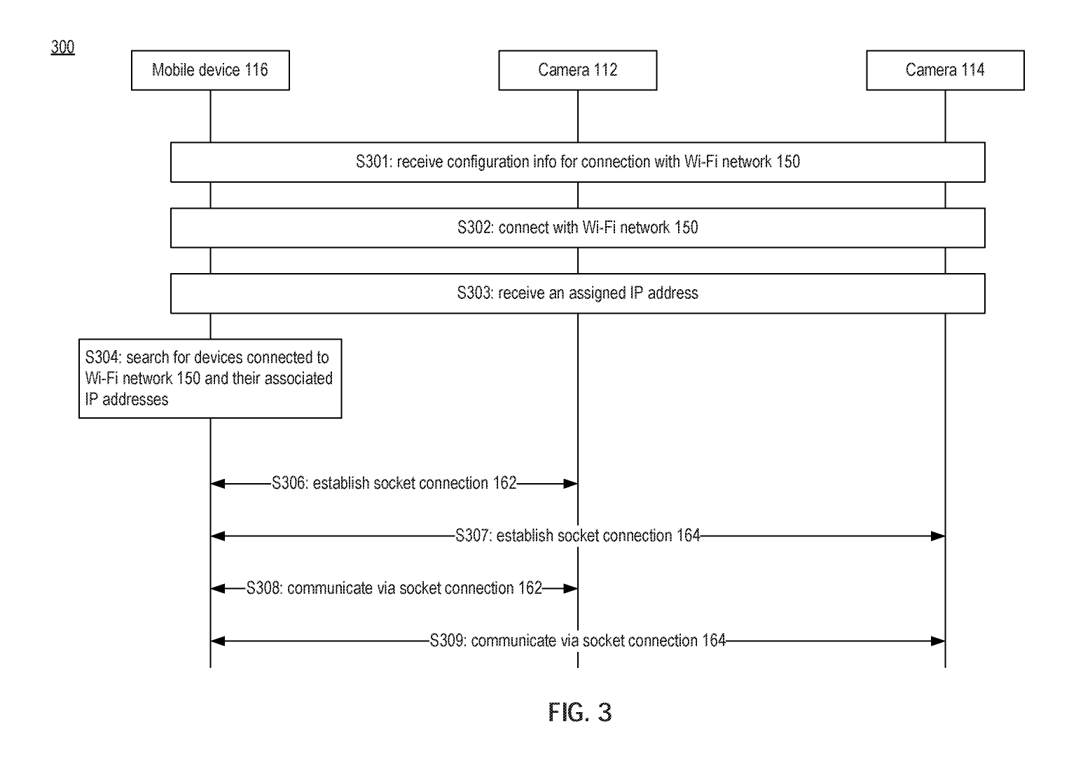

FIG. 3 is a flowchart of an exemplary method 300 consistent with the present disclosure. Method 300 can be performed by a camera network system (e.g., system 100 of FIG. 1) that includes a mobile device (e.g., mobile device 116), a plurality of cameras (e.g., cameras 112 and 114), and a network connectivity provider 102 that provides a Wi-Fi network 150.

After starting, each of cameras 112 and 114 and mobile device 116 receives configuration information for connection with Wi-Fi network 150, in step S301. The configuration information may include, for example, the SSID of Wi-Fi network 150, a password for connecting with the network, etc. The configuration information can be received from, for example, a storage device, an input interface, an imaging interface, etc. After receiving the configuration information, each of cameras 112 and 114 and mobile device 116 connects with Wi-Fi network 150, in step S302. To establish the connection, each of the devices transmits a request including the SSID and password to network connectivity provider 102. In some embodiments, each of cameras 112 and 114 may be preconfigured to operate in Wi-Fi AP mode and, upon receiving the configuration information, can operate in Wi-Fi STA mode to connect with Wi-Fi network 150. After establishing connections with Wi-Fi network 150, each of cameras 112 and 114 and mobile device 116 receives an assigned IP address from network connectivity provider 102, in step S303.

Although FIG. 3 illustrates each of steps S301, S302, and S303 as single steps, it is understood that each of cameras 112 and 114 and mobile device 116 may receive configuration information, connect with Wi-Fi network 150, and receive an assigned IP address at different times.

After receiving its assigned address, mobile device 116 searches for devices connected to Wi-Fi network 150 and their associated IP addresses, in step S304. In some embodiments, mobile device 116 receives the information from network connectivity provider 102. In some embodiments, mobile device 116 may broadcast a message (e.g., a ping message) to all the devices on Wi-Fi network 150, and obtain the IP addresses of these devices when they reply to the broadcast message.

After receiving the list of devices and their associated IP addresses, including those of cameras 112 and 114, mobile device 116 then establishes network socket connection 162 with camera 112, in step S306. Mobile device 116 also establishes network socket connection 164 with camera 114, in step S307. The network socket connections can be based on TCP sockets. To establish the network socket connections, mobile device 116 may be configured as a TCP client and transmit network socket connection requests including the IP addresses of cameras 112 and 114. Cameras 112 and 114 receive their respective network socket connection request and assign a port for the network socket connections.

After establishing the network socket connections, mobile device 116 communicates with camera 112 via network socket connection 162, in step S308. Mobile device 116 also communicates with camera 114 via network socket connection 164, in step S309. The communications can be related to coordinating operations between cameras 112 and 114.

Computer programs created on the basis of the written description and methods of this specification are within the skill of a software developer. The various programs or program modules may be created using a variety of programming techniques. For example, program sections or program modules may be designed in or by means of Java, C, C++, assembly language, or any such programming languages. One or more of such software sections or modules may be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A video camera system comprising:
a video camera connectable to a wireless network via a wireless access point; and
a user device including:
a memory storing a set of instructions; and
a hardware processor configured to execute the set of instructions to:
establish a connection with the wireless network;
determine that the video camera is connected to the wireless network; and
establish a socket connection with the video camera.

2. The system of claim 1, wherein the video camera is configured to receive configuration data for connecting to the wireless network, the configuration data including an SSID of the wireless network and a password associated with the wireless access point.

3. The system of claim 2, wherein the video camera is configured to receive a configuration file that includes the configuration data.

4. The system of claim 2, wherein the video camera is configured to receive the configuration data over an imaging interface.

5. The system of claim 2, wherein the video camera is configured to operate in Wi-Fi access point mode, and to operate in Wi-Fi station mode upon receiving the configuration data.

6. The system of claim 1, wherein the hardware processor is configured to execute the set of instructions to:
receive, via the wireless network, an IP address of the video camera; and
establish the socket connection with the video camera based on the received IP address.

7. The system of claim 6, wherein the hardware processor is configured to execute the set of instructions to receive the IP address via the wireless access point.

8. The system of claim 6, wherein the hardware processor is configured to execute the set of instructions to:
transmit a broadcast message over the wireless network; and
receive, from the at least one video camera, a reply to the broadcast message, wherein the reply includes the IP address.

9. The system of claim 1, wherein the video camera is a first video camera, further comprising a second video camera connectable to the wireless network; wherein the hardware processor is configured to:
establish a first socket connection with the first video camera and a second socket connection with the second video camera over the wireless network;
receive, via an interface, an instruction to coordinate between a first operation at the first video camera and a second operation at the second video camera; and
transmit the received instruction to the first and second cameras respectively via the first and second socket connections.

10. A method for operating a video camera connectable to a wireless network via a wireless access point, comprising:
establishing a connection with the wireless network;
determining that the video camera is connected to the wireless network; and
establishing a socket connection with the video camera.

11. The method of claim 10, wherein the video camera is provided with configuration data for connecting to the wireless network, the configuration data including an SSID of the wireless network and a password associated with the wireless access point.

12. The method of claim 11, wherein the configuration data is provided in a configuration file.

13. The method of claim 11, where the configuration data is provided to the video camera over an imaging interface.

14. The method of claim 11, wherein the configuration data causes the video camera to change from operating in a Wi-Fi access point mode to operating in a Wi-Fi station mode.

15. The method of claim 10, further comprising:
receiving, via the wireless network, an IP address of the video camera; and
establishing the socket connection with the video camera based on the received IP address.

16. The method of claim 15, further comprising:
receiving the IP address via the wireless access point.

17. The method of claim 15, further comprising:
transmitting a broadcast message over the wireless network; and
receiving, from the at least the video camera, a reply to the broadcast message, wherein the reply includes the IP address.

18. The method of claim 10, wherein the video camera is a first video camera, the method further comprising:
establishing a first socket connection with the first video camera and a second socket connection with a second video camera over the wireless network;
receiving, via an interface, an instruction to coordinate between a first operation at the first video camera and a second operation at the second video camera; and
transmitting the received instruction to the first and second video cameras respectively via the first and second socket connections.

19. A non-transitory computer readable medium storing instructions executable by a hardware processor to cause the hardware processor to perform a method for operating a video camera connectable to a wireless network via a wireless access point, comprising:
establishing a connection with the wireless network;
determining that the video camera is connected to the wireless network; and
establishing a socket connection with the video camera.

20. The medium of claim 19, wherein the video camera is a first video camera, the method further comprising:
establishing a first socket connection with the first video camera and a second socket connection with a second video camera over the wireless network;
receiving, via an interface, an instruction to coordinate between a first operation at the first video camera and a second operation at the second video camera; and
transmitting the received instruction to the first and second video cameras respectively via the first and second socket connections.
